(19) United States
(12) Patent Application Publication
(10) Pub. No.: US 2013/0278870 A1
(43) Pub. Date: Oct. 24, 2013

(54) LCD Device, Manufacturing Method Thereof and Optical Film

(71) Applicants: Yicheng Kuo, Shenzhen (CN); Shihhsiang Chen, Shenzhen (CN); Gang Yu, Shenzhen (CN); Gege Zhou, Shenzhen (CN); Jiaqiang Wang, Shenzhen (CN)

(72) Inventors: Yicheng Kuo, Shenzhen (CN); Shihhsiang Chen, Shenzhen (CN); Gang Yu, Shenzhen (CN); Gege Zhou, Shenzhen (CN); Jiaqiang Wang, Shenzhen (CN)

(21) Appl. No.: 13/512,719

(22) PCT Filed: Apr. 24, 2012
(86) PCT No.: PCT/CN12/74566

§ 371 Date: May 30, 2012

(51) Int. Cl. G02F 1/1333; G02B 5/20; H01J 9/20

(52) U.S. Cl. 349/84; 445/24; 359/892

(57) ABSTRACT

The invention provides an LCD device, a manufacturing method thereof, and an optical film. The LCD device includes optical films, and an LCD panel; an edge(s) of the optical film is provided with a folded edge(s), and the LCD panel is arranged on the folding edges. In the invention, because the folded edges are arranged on the optical film of the LCD device, and the LCD panel is arranged on the folding edges, no interval is reserved between the edges of the LCD panel and the optical films, thereby preventing the LCD device from generating light leakage because the LCD panel is supported by the separated middle frames. In addition, because no interval is reserved between the edges of the LCD panel and the folded edges for support, the whole edges of the LCD panel are continuously supported instead of only supporting the four corners by the separated middle frames, thereby increasing the compression strength of the LCD panel, effectively preventing the black matrix or other structure(s) from moving because of oversize deformation when being stressed, and preventing light leakage and water ripple phenomena.

### TECHNICAL FIELD

The invention relates to the field of liquid crystal displays (LCDs), and more particularly to an LCD device, a manufacturing method thereof, and an optical film.

### BACKGROUND

LCD devices, with low power consumption and small volume, are more and more popular. However, with the development of LCD technology, some existing problems are discovered.

FIG. 1 shows a structure of a conventional LCD module for an LCD device. The structure of the LCD module is connected by a middle frame 25, to enable an LCD panel 10 and a backlight module 20 to be assembled together so as to achieve the normal operation of the LCD device. The LCD panel 10 is positioned on the uppermost part and supported by a support part 251 of the middle frame 25, and optical films are pressed below the middle frame 25. The optical films include a first optical film 22, a second optical film 23, and a third optical film 24. To reduce material cost, the inventor has tried to use the scheme shown in FIG. 2: the four corners of the LCD panel are respectively supported by four separated middle frames 25 of LCD module. However, the LCD module assembled through such structure has a problem, namely because an interval exists between the separated middle frames 25, the LCD panel is downwards bent when being stressed, the black matrix on the LCD panel is moved, light leakage is generated, and then water ripple phenomenon is generated; thus, the image quality of the LCD device is seriously affected. In addition, for the separated middle frames 25, the interval between the separated middle frames 25 positioned on the LCD panel is too large, resulting in an excessive gap between the LCD panel and the optical film, and then resulting in side light leakage; thus, the optical quality of the whole module is seriously affected.

### SUMMARY

In view of the above-described problems, the aim of the invention is to provide an LCD device, a manufacturing method thereof with high compression resistance and excellent display effect, and an optical film.

The aim of the invention is achieved by the following technical scheme.

An LCD device comprises optical films, and an LCD panel; an edge(s) of the optical film(s) is provided with a folded edge(s), and the LCD panel is arranged on the folded edge(s).

Preferably, the LCD device comprises middle frames; the middle frames are provided with lug bosses for limiting the edges of the LCD panel, and the four edges of the LCD panel are tightly butted by the lug bosses; thus, the degree of freedom of the LCD panel in the plane direction of the panel surface is limited.

Preferably, the optical films comprise multiple layers of optical films; the folded edge is formed by folding the edge of any layer of the optical films to the upper surface of the uppermost layer. The process is simple by folding the optical film(s) to form the folded edge.

Preferably, the optical films comprise a first optical film positioned on the bottom layer, a second optical film positioned on the middle layer, and a third optical film positioned on the uppermost layer; the folded edge is formed by folding the edge of the third optical film to the upper surface thereof. The folded edge is formed by folding the optical film itself, facilitating the operation during assembly.

Preferably, the optical films comprise a first optical film positioned on the bottom layer, a second optical film positioned on the middle layer, and a third optical film positioned on the uppermost layer; the folded edge is formed by folding the edge of the first optical film to the upper surface of the third optical film. Thus, the second optical film and the third optical film can be positioned by the first optical film positioned on the bottom layer.

Preferably, the folded edge is a thin sheet which is a separated structure from the optical film and is stuck on the optical film, thereby favoring the processing of the optical films without cutting the conventional optical films or changing the process thereof

A manufacturing method of the LCD device comprises the following steps:

A: Arranging the folded edges at the edges of the optical film; and

B: Arranging the LCD panel on the folded edges.

Preferably, in the step A, the folded edge arranged at the edge of the optical film is formed by folding a pre-folded edge which is integrated with the optical film, and a pre-folded line is arranged between the pre-folded edge and the body of the optical film. Thus, the optical film is folded in accordance with the predetermined path, and the structure at the folding position is leveled off.

Preferably, in the step A, the folded edges arranged at the edges of the optical film is formed by sticking the pre-folded edges which is separated from the optical film on the optical film, thereby favoring the processing of the optical films without cutting the conventional optical films or changing the process thereof

An optical film(s), an edge(s) of the optical film is provided with a folded edge(s).

In the invention, because the folded edges is arranged on the optical film of the LCD device, and the LCD panel is arranged on the folded edges, no interval is reserved between the edges of the LCD panel and the folded edges at the edges of the optical films, but only a slight gap is reserved between the LCD panel and the optical films in a visible area. Thus, even the outer side of the LCD panel is not provided with middle frame(s), light leakage is not easily generated because of the design of the black matrix on the LCD panel. In addition, because the folded edges for support of the edges of the LCD panel is continuous folded edges arranged at the edges of the LCD panel, namely the length of the folded edge is at least more than that of the edge of the LCD panel, the whole edges of the LCD panel are supported by continuous support surfaces instead of only supporting the four corners by the separated middle frames, thereby increasing the compression strength of the LCD panel, effectively preventing the black matrix or other structure(s) from moving because of oversize deformation when being stressed, and preventing light leakage and water ripple phenomena. Furthermore, in the invention, the optical film(s) itself is folded or the cutting material of the optical films is used to form the folded edges on the optical film(s), and members are not required to be separately arranged to make the folded edges on the optical films, thereby facilitating processing as long as a tiny process change is conducted, and resulting in low production cost.

### BRIEF DESCRIPTION OF FIGURES

FIG. 1 is a simplified structure diagram of a conventional LCD module;

FIG. 2 is a simplified structure diagram of separated middle frames of a conventional LCD module;

FIG. 3 is a simplified structure diagram of an LCD module of an example of the invention;

FIG. 4 is a process diagram of an optical film of an example of the invention;

FIG. 5 is a simplified structure diagram of an optical film of an example of the invention;

FIG. 6 is a schematic diagram of a third optical film when being folded of an example of the invention;

FIG. 7 is a simplified structure diagram of another optical film of an example of the invention; and

FIG. 8 is a simplified structure diagram of a third optical film of an example of the invention.

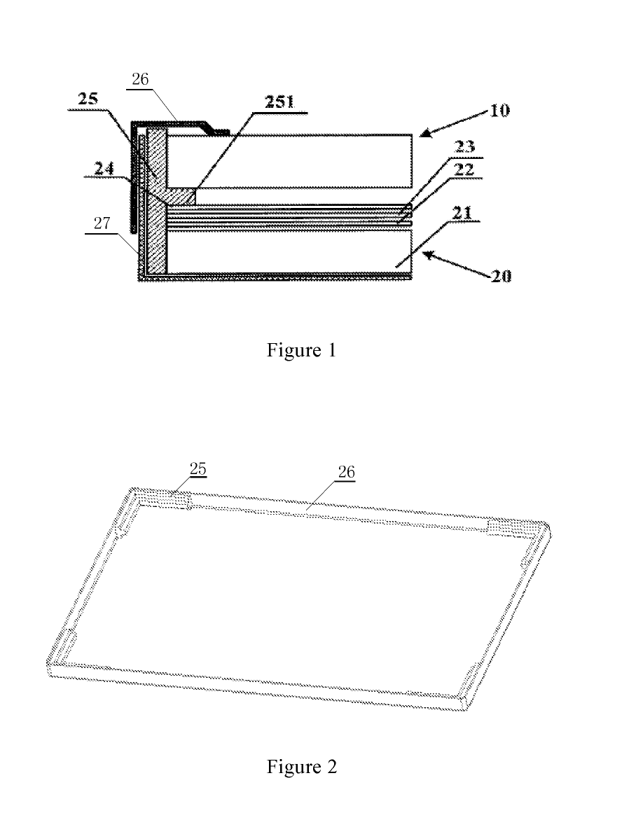

Legends: 10. LCD panel; 20. backlight module; 21. light guide panel (LGP); 22. first optical film; 23. second optical film; 24. third optical film; 25. middle frame; 26. outer frame; 27. backplane; 241. folded edge; 242. pre-folded edge; 243. pre-folded line; 251. support part; 252. lug boss; 77. gap.

### DETAILED DESCRIPTION

The invention will further be described in detail in accordance with the figures and the preferable examples.

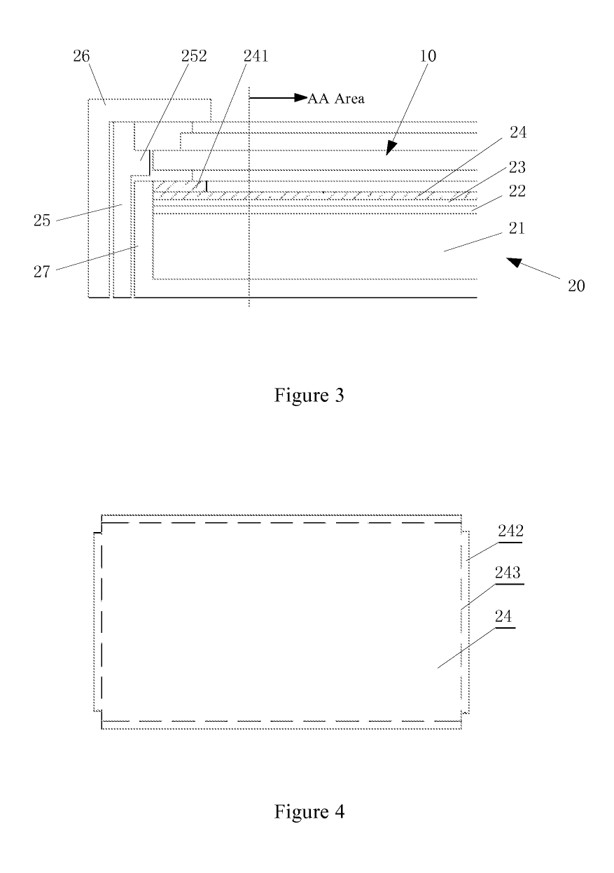

FIG. 3 shows an LCD module of an LCD device of the invention, comprising a backlight module 20, and an LCD panel 10; wherein the backlight module 10 comprises a backplane 27, an LGP 21 arranged in the backplane 27, a first optical film 22, a second optical film 23 and a third optical film 24 which are arranged on the light emitting surface of the LGP 21, middle frame(s) 25 arranged on the periphery of the backplane 27, and an outer frame 26 arranged on the periphery of the middle frame 25; folded edges 241 is arranged on the upper surface of the edges of the third optical film 25 of the uppermost layer of the optical films of the backlight module 20, the LCD panel 10 is arranged on the folded edges 241 of the third optical film 24, and the LCD panel 10 is supported by the folded edges 241. Preferably, the width of the folded edge is outside the effective active area of the LCD panel 10, to avoid affecting the normal display of the LCD panel 10. Because the LCD panel 10 is supported by the folded edges 241, no interval is reserved between the edges of the LCD panel 10 and the folded edges 241, namely the interval between the LCD panel 10 and the optical films is sealed by the folded edge 241, thereby preventing the LCD device from generating light leakage because the LCD panel is supported by the separated middle frames. In addition, because no interval is reserved between the edges of the LCD panel 10 and the folded edges 241 for support, namely the length of the folded edge is at least more than that of the edge of the LCD panel, the whole edges of the LCD panel are continuously supported instead of only supporting the four corners by the separated middle frames, thereby increasing the compression strength of the LCD panel 10, effectively preventing the black matrix or other structure(s) from moving because of oversize deformation when being stressed, and preventing light leakage and water ripple phenomena.

The middle frame 25 is still of a separated structure, thereby favoring the reduction of the manufacturing cost of the middle frame 25 of the backlight module; the middle frame 25 is provided with a lug boss 252, the lug boss 252 is butted with the edge of the LCD panel 10, and the four separated middle frames 25 are respectively arranged on the four corners of the LCD panel 10 to limit the degree of freedom of the LCD panel 10 in the plane direction of the panel surface. The degree of freedom of the LCD panel 10 in the direction perpendicular to the panel surface is limited by the folded edges 241 and the outer frame 26.

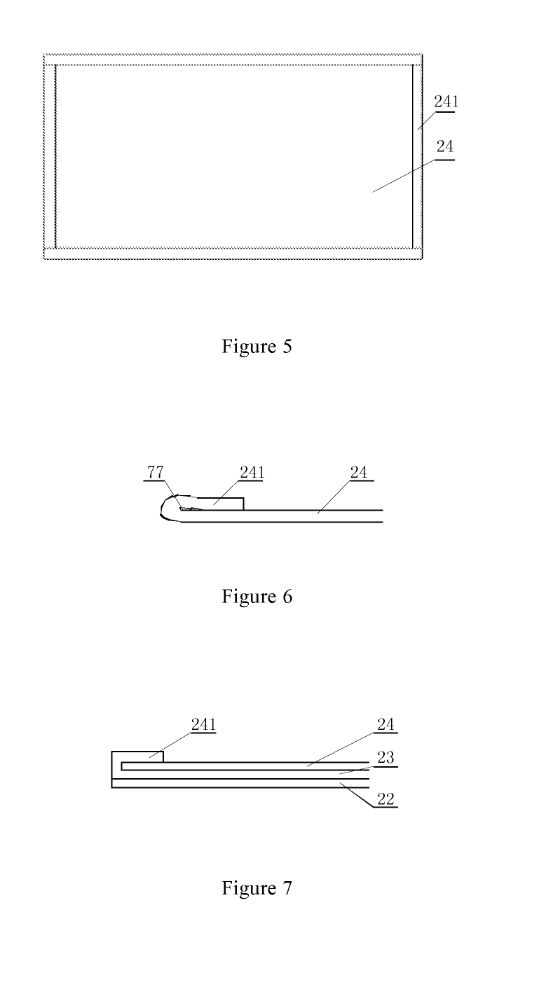

In the example of the invention, the optical films comprise a first optical film 22 positioned on the bottom layer, a second optical film 23 positioned on the middle layer, and a third optical film 24 positioned on the uppermost layer; wherein the folded edges 241 is arranged on the third optical film 241; the number of the optical films is set as required. FIG. 4 and FIG. 5 show a manufacturing method and a structure of the third optical film 24. As shown in FIG. 4, a pre-folded edge(s) 242 which is integrated with the third optical film 24 is arranged at the edge(s) of the third optical film 24, and a pre-folded line 243 is arranged between the pre-folded edge 242 and the body of the third optical film 24; the pre-folded line 243 can be a discontinuous crack arranged at the edge of the third optical film 24, and can be an impression as well, thereby facilitating folding the pre-folded edge 242 to form the folded edge 241 shown in FIG. 5.

Optionally, the pre-folded edge separated from the third optical film is additionally arranged, namely a thin sheet is additionally arranged, and the pre-folded edge (the thin sheet) is stuck on the third optical film by sticking or other modes to form the folded edge. The thin sheets can be made of the cutting material of the optical film(s). Thus, the folded edges can be formed on the conventional optical films standardly processed without changing overmuch processing technology of the optical films; thus, the production cost is saved.

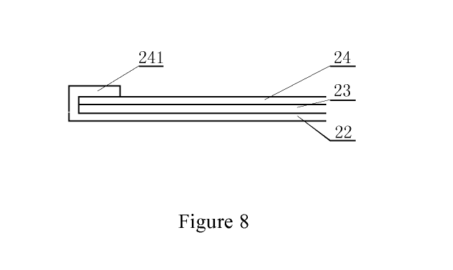

As shown in FIG. 4, the pre-folded edges 242 are folded to the upper surface of the third optical film 24 to form the folded edges 241 shown in FIG. 5. However, because the pre-folded edge is folded instead of being broken, a certain gap 77 near the pre-folded line 243 is reserved between the folded edge 241 and the third optical film 24 to enable this place to be slightly protruded (as shown in FIG. 6). To avoid generating such situation, as shown in FIG. 7, the second optical film 23 is folded to the upper surface of the third optical film 24 to form the folded edge 241; therefore, no protruding situation occurs in the folding position. Optionally, as shown in FIG. 8, the first optical film 22 is folded to the upper surface of the third optical film 24 to form the folded edge 241 to enable the first optical film 22 to wrap the second optical film 23 and the third optical film 24, so as to play a role of positioning the second optical film 23 and the third optical film 24.

The invention is described in detail in accordance with the above contents with the specific preferred examples. However, this invention is not limited to the specific examples. For the ordinary technical personnel of the technical field of the invention, on the premise of keeping the conception of the invention, the technical personnel can also make simple deductions or replacements, and all of which should be considered to belong to the protection scope of the invention.

We claim:

1. An LCD device, comprising: optical films, and an LCD panel; wherein the edge(s) of said optical film(s) is provided with a folded edge, and said LCD panel is arranged on said folded edge(s).

2. The LCD device of claim 1, wherein said LCD device comprises middle frames; said middle frames are provided with lug bosses for limiting the edges of said LCD panel.

3. The LCD device of claim 1, wherein said optical films comprise multiple layers of optical films; said folded edges are formed by folding the edges of any layer of said optical films to the upper surface of the uppermost layer.

4. The LCD device of claim 3, wherein said optical films comprise a first optical film positioned on the bottom layer, a second optical film positioned on the middle layer, and a third optical film positioned on the uppermost layer; said folded edges are formed by folding the edges of said third optical film to the upper surface thereof

5. The LCD device of claim 3, wherein said optical films comprise a first optical film positioned on the bottom layer, a second optical film positioned on the middle layer, and a third optical film positioned on the uppermost layer; said folded edges are formed by folding the edges of said first optical film to the upper surface of said third optical film.

6. The LCD device of claim 1, wherein said folded edges are thin sheets which are a separated structure from said optical film and are stuck on said optical film.

7. A manufacturing method of the LCD device, comprising: the following steps:
A: arranging folded edges at the edges of said optical film; and
B: arranging said LCD panel on said folded edges.

8. The manufacturing method of the LCD device of claim 7, wherein in said step A, said folded edge arranged at the edge of said optical film is formed by folding a pre-folded edge which is integrated with said optical film, and a pre-folded line is arranged between said pre-folded edge and the body of said optical film.

9. The manufacturing method of the LCD device of claim 7, wherein in said step A, said folded edge arranged at the edge of said optical film is formed by sticking said pre-folded edge which is separated from said optical film on said optical film.

10. An optical film(s), wherein the edge(s) of said optical film are provided with folded edges.
